(19) United States
(12) Patent Application Publication
(10) Pub. No.: US 2021/0296774 A1
(43) Pub. Date: Sep. 23, 2021

(54) Integrated Cellular and Ultra-Wideband Antenna System for a Mobile Electronic Device

(71) Applicant: Google LLC, Mountain View, CA (US)

(72) Inventors: Ming Zheng, Santa Clara, CA (US); Chun Kit Lai, Sunnyvale, CA (US); Seckin Sahin, Santa Clara, CA (US); Krishna Katragadda, Santa Clara, CA (US); Vijay L. Asrani, San Jose, CA (US)

(73) Assignee: Google LLC, Mountain View, CA (US)

(21) Appl. No.: 17/233,949

(22) Filed: Apr. 19, 2021

Related U.S. Application Data
(60) Provisional application No. 63/167,934, filed on Mar. 30, 2021.

(51) Int. Cl. H01Q 5/25; H01Q 3/26; H01Q 21/28; H01Q 1/24

(52) U.S. Cl. CPC H01Q 5/25; H01Q 1/243; H01Q 21/28; H01Q 3/2611

(57) ABSTRACT

This document describes an integrated cellular and ultra-wideband antenna system for a mobile electronic device. The cellular and ultra-wideband antenna are located in close proximity to one another, along with a circuit designed to enhance isolation between the two antennas. The circuit is also designed to enhance the efficiency of the cellular antenna by permitting the ultra-wideband antenna to generate an additional resonance in the cellular band. The integrated cellular antenna and ultra-wideband antenna results in reduced mutual coupling and performance degradation of the antennas, and the cellular antenna may gain enhanced bandwidth and efficiency.

### CROSS-REFERENCE TO RELATED APPLICATION

This application claims priority to U.S. Provisional Application Ser. No. 63/167,934, filed Mar. 30, 2021, the entire disclosure of which is hereby incorporated by reference.

### SUMMARY

This document describes an integrated cellular and ultra-wideband antenna system for a mobile electronic device. In one aspect, an antenna system for a mobile electronic device includes a cellular antenna and an ultra-wideband antenna. The antenna system further includes a circuit that connects a feed port of the ultra-wideband antenna to an ultra-wideband module. The ultra-wideband module is configured to at least transmit or receive one or more ultra-wideband radio frequencies. The circuit is configured, through a matching topology, to enhance isolation between the ultra-wideband antenna and the cellular antenna. The circuit further provides additional resonance in the cellular band to enhance cellular bandwidth and efficiency.

This summary is provided to introduce simplified concepts of techniques and systems directed at integrating cellular and ultra-wideband antennas for a mobile electronic device, the concepts of which are further described below in the Detailed Description and Drawings. This summary is not intended to identify essential features of the claimed subject matter, nor is it intended for use in determining the scope of the claimed subject matter.

### BRIEF DESCRIPTION OF THE DRAWINGS

The details of one or more aspects of an integrated cellular and ultra-wideband antenna system for a mobile electronic device are described in this document with reference to the following drawings. The same numbers may be used throughout the drawings to reference like features and components.

FIG. 1-1 illustrates an example environment for an integrated cellular and ultra-wideband antenna system for a mobile electronic device.

FIG. 1-2 illustrates a top-down view of a metal frame with the integrated cellular and ultra-wideband antenna system for a mobile electronic device.

FIG. 2-1 illustrates a detailed view of an integrated cellular and ultra-wideband antenna system for a mobile electronic device.

FIG. 2-2 illustrates an example location of a circuit for an integrated cellular and ultra-wideband antenna system for a mobile electronic device.

FIG. 2-3 illustrates a detailed description of the example circuit for an integrated cellular and ultra-wideband antenna system for a mobile electronic device.

FIG. 3 illustrates an example antenna pattern for an integrated cellular and ultra-wideband antenna system for a mobile electronic device.

### DETAILED DESCRIPTION

Overview

A mobile electronic device may contain several antennas used for many different purposes. Cellular communications, Global Navigation Satellite System (GNSS) receivers, and wireless networking require antennas to operate. However, as the quantity of antennas increases in the mobile electronic device, some issues may arise, one of which is mutual coupling. Mutual coupling is a phenomenon that occurs when two antennas are near one another. The receiver of one antenna absorbs energy from a nearby transmitting antenna, preventing the absorbed energy from propagating to an intended antenna located at a further distance. The result is that the overall efficiency of the antenna system is diminished.

Another issue involves the various frequency bandwidths of different antennas. Antennas that are configured to operate at lower frequencies generally have a longer range and are less susceptible to obstructions and barriers (e.g., walls, buildings, the casing of the mobile electronic device) than antennas configured to operate at higher frequencies. However, data transfer rates, or data bandwidth, are generally greater at higher frequencies. For example, some typical ultra-wideband frequencies that may be utilized on a mobile electronic device may range between approximately 6.5 gigahertz (GHz) to 8.0 GHz. The ultra-wide frequency band is higher than the typical frequencies used in cellular communications which are mostly below 5 GHz (e.g., 1.7 GHz to 2.7 GHz), some wireless networks (e.g., 2.4 GHz), or by GNSS systems (e.g., 1.175 GHz, 1.575 GHz). As such, ultra-wideband antennas are more sensitive to their location in relation to barriers than are cellular antennas, some wireless antennas, GNSS antennas, or any other antennas configured for lower frequencies.

With the proliferation of antennas in mobile electronic devices, manufacturers continue to explore techniques and systems to overcome mutual coupling and improve antenna bandwidth, efficiency, and range.

This document describes an integrated cellular and ultra-wideband antenna system for a mobile electronic device. The integrated antenna system includes locating the cellular and ultra-wideband antenna in close proximity to one another and adding a circuit that is coupled to the ultra-wideband antenna and configured to enhance isolation between the two antennas. The circuit is also configured to enhance the efficiency of the cellular antenna by permitting the ultra-wideband antenna to generate an additional resonance in the cellular band. By integrating the cellular antenna and ultra-wideband antenna using the techniques described herein, mutual coupling and performance degradation of the antennas may be reduced, and the cellular antenna may gain enhanced bandwidth and efficiency.

Example System

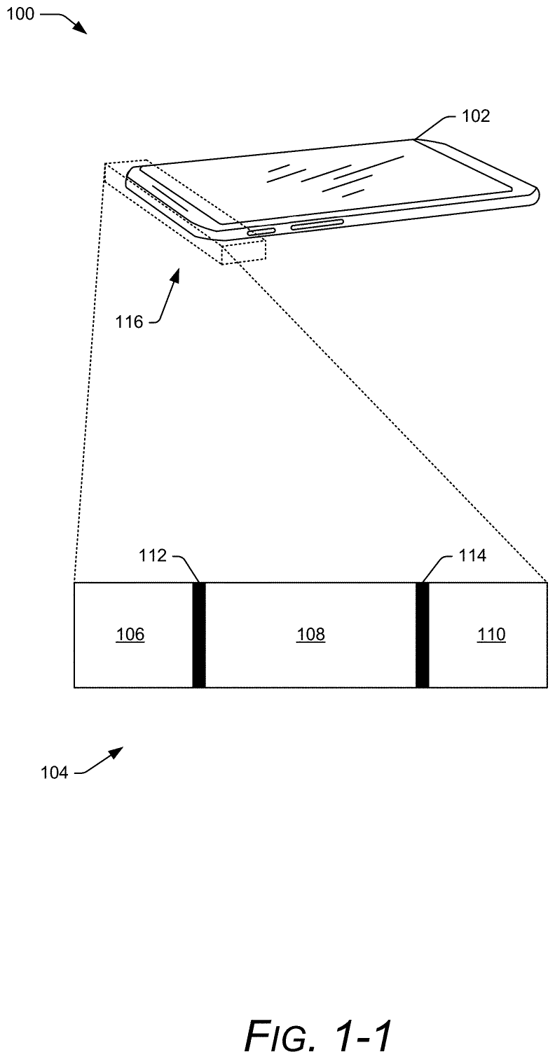

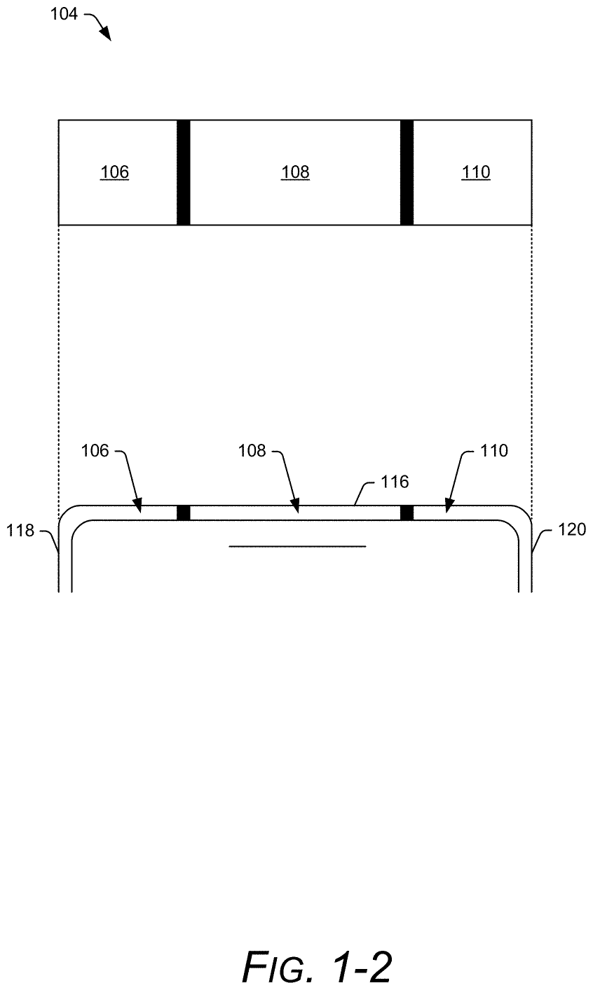

FIG. 1-1 illustrates an example environment 100 for an integrated cellular and ultra-wideband antenna system for a mobile electronic device 102. In this example environment 100, the mobile electronic device 102 may include several antennas associated with different bands on the electromagnetic spectrum. Some of the antennas may be associated with cellular communications, ultra-wideband communications, or wireless networking. In this aspect, a metal frame 104 surrounding a perimeter of the mobile electronic device 102 includes a wireless antenna 106. In other aspects, wireless antenna 106 may be an antenna for a different application, such as GNSS reception. The metal frame 104 also includes an ultra-wideband antenna 108 and a cellular antenna 110. In the example environment 100, only three antennas are illustrated as being integrated with the metal frame 104; however, the metal frame 104 may include fewer or greater antennas than are illustrated. Further, the mobile electronic device 102 may include additional antennas not located on the metal frame 104. The antennas may be associated with different applications, including but not limited to cellular communications, wireless communications, peer-to-peer communications, and GNSS reception.

A gap 112 separates the wireless antenna 106 and the ultra-wideband antenna 108. A gap 114 separates the ultra-wideband antenna 108 and the cellular antenna 110. The gaps 112 and 114 may have a non-conductive material that electrically isolates each neighboring pair of antennas. That is, gap 112 electrically isolates the wireless antenna 106 and the ultra-wideband antenna 108, and gap 114 electrically isolates the ultra-wideband antenna 108 and the cellular antenna 110.

In this aspect, if a user was holding the mobile electronic device in a portrait orientation, the antennas 106, 108, and 110 are positioned along a top side 116 of the metal frame 104. In other aspects, the antennas 106, 108, and 110 may be positioned along any of the other three sides of the metal frame 104.

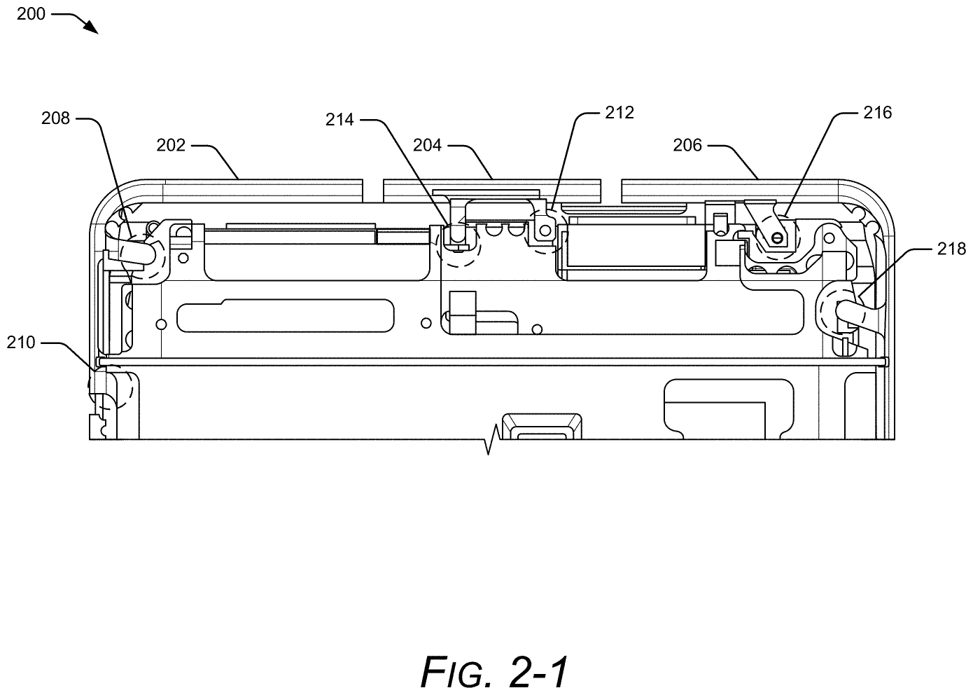

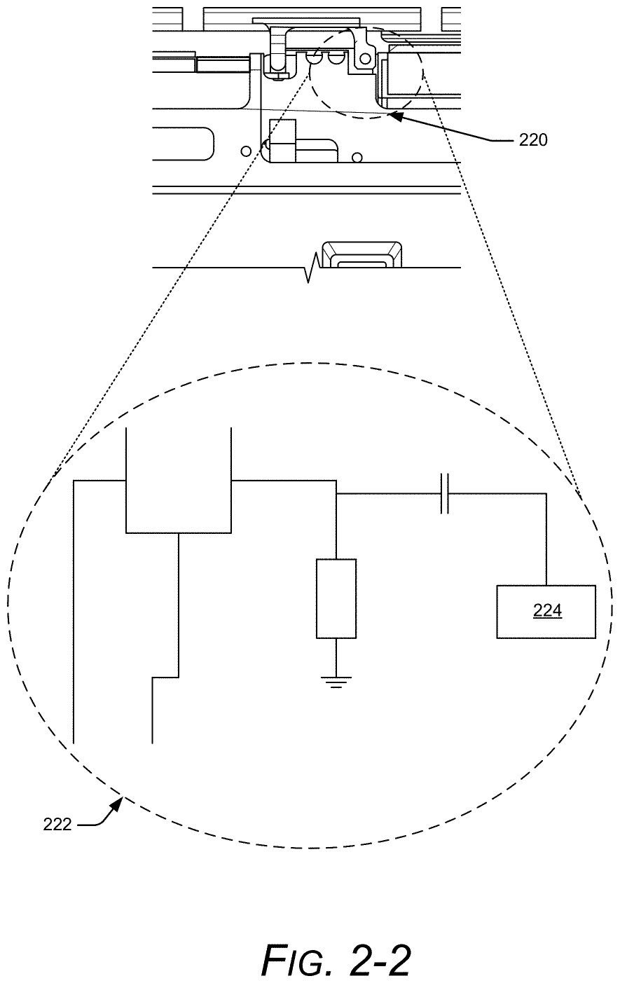

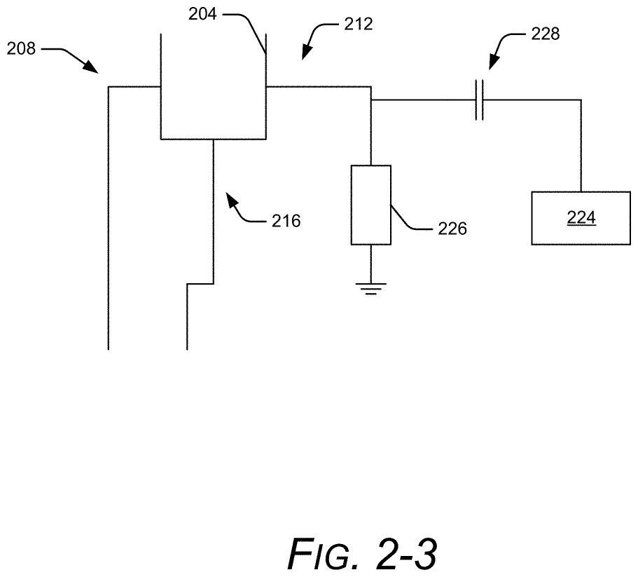

FIG. 1-2 illustrates a top-down view of a metal frame with the integrated cellular and ultra-wideband antenna system for the mobile electronic device 102. The wireless antenna 106, the ultra-wideband antenna 108, and the cellular antenna 110 are positioned coplanar to each other and along the top side 116 of the metal frame 104. Additionally, in this aspect, the wireless antenna 106 wraps around one corner of the metal frame 104, forming a portion of a left side 118 of the metal frame 104 that is orthogonal to the top side 116. Likewise, the cellular antenna 110 wraps around another corner of the metal frame 104, forming a portion of a right side 120 of the metal frame 104 that is orthogonal to the top side 116 and parallel to the left side 118.

FIG. 2-1 illustrates a detailed view 200 of an integrated cellular and ultra-wideband antenna system for a mobile electronic device. The view 200 illustrates example feed ports and ground ports of antennas that may be located on a metal frame of the mobile electronic device. The view 200 further illustrates the orientation of each port of each antenna in relation to the ports of the other antennas. The feed ports of each antenna are coupled to a module that at least transmits or receives signals related to the application of the respective antenna. The ground ports are coupled to a ground plane of the mobile electronic device.

In this aspect, a wireless antenna 202 (e.g., the wireless antenna 106 from FIG. 1-1), an ultra-wideband antenna 204 (e.g., the ultra-wideband antenna 108 from FIG. 1-1), and a cellular antenna 206 (e.g., the cellular antenna 110 from FIG. 1-1) are positioned on a metal frame surrounding a perimeter of the mobile electronic device. The wireless antenna 202 includes a feed port 208 and a ground port 210. The ultra-wideband antenna 204 includes a feed port 212 and a ground port 214. The cellular antenna 206 includes a feed port 216 and a ground port 218. The feed port 212 of the ultra-wideband antenna 204 may be positioned such that it is on a first end of the ultra-wideband antenna 204 that is closer to the cellular antenna 206 than a second end that includes the ground port 218.

FIG. 2-2 illustrates an example location 220 of a circuit 222 for an integrated cellular and ultra-wideband antenna system for a mobile electronic device. The circuit 222 may be located in close proximity to the feed port 212 of the ultra-wideband antenna 204, and, through a matching topology, couples the feed port 212 of the ultra-wideband antenna 204 to an ultra-wideband module 224 capable of at least transmitting or receiving ultra-wideband signals. In some aspects, the ultra-wideband antenna 204, the circuit 222, and the ultra-wideband module 224 may be configured to at least transmit or receive signals on bandwidths centered on one or both a 6.5 GHz frequency or an 8.0 GHz frequency. In other aspects, the ultra-wideband antenna 204, the circuit 222, and the ultra-wideband module 224 may be configured to at least transmit or receive signals on bandwidths centered on other frequencies within the ultra-wideband spectrum.

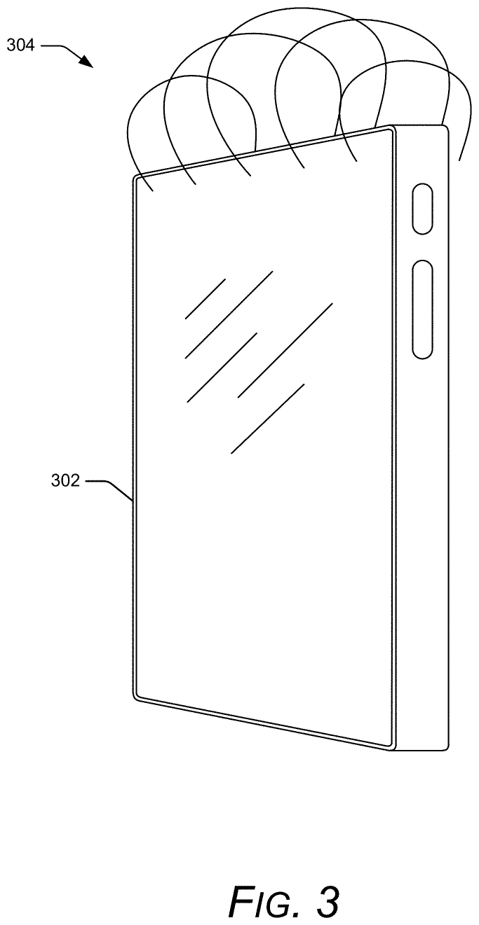

FIG. 2-3 illustrates a detailed description of the example circuit 222 for an integrated cellular and ultra-wideband antenna system for a mobile electronic device. The circuit 222 may include a shunt inductor 226 connected to a ground plane of the mobile electronic device and a capacitor 228 that is connected in series with the ultra-wideband module 224. The inductor 226 may have an inductance that generates an additional resonance in the cellular band. In this case, the ultra-wideband antenna may act as a parasitic element for the cellular antenna 206, resulting in enhanced cellular bandwidth and efficiency. The capacitor 228 may have a capacitance that enables the ultra-wideband signal to propagate between the ultra-wideband module 224 and the ultra-wideband antenna 204. Furthermore, the capacitor 228 may isolate the cellular resonance from the ultra-wideband module 224. For simplicity, a single capacitor and inductor are illustrated in FIG. 2-3; however, the example circuit 222 may include any number of capacitors or inductors to generate an additional resonance in the cellular band and isolate the two antennas. Additionally, some active components, such as active tunable components, have not been illustrated, but they may be included in some aspects of the circuit 222. Isolation between UWB antenna 108 and cellular antenna 110 may exceed 12 dB.

FIG. 3 illustrates an example antenna pattern 304 for an integrated cellular and ultra-wideband antenna system for a mobile electronic device 302 (e.g., the mobile electronic device 102 from FIG. 1-1). The antenna pattern 304 illustrates the radiation of signal energy emanating from an ultra-wideband antenna located for example on a top edge of the mobile electronic device 302. Because ultra-wideband signals propagate up to 200 meters if unobstructed by external objects, the location of the ultra-wideband antenna may have widely varying results on its range and efficiency. Being located on the edge of the mobile electronic device 302, the ultra-wideband antenna may not be hampered by some barriers (e.g., the casing of the mobile electronic device, hands of a user) and may provide increased range of the ultra-wide antenna and higher efficiency of the propagated signal.

### CONCLUSION

Although aspects of techniques and systems directed at integrated cellular and ultra-wideband antennas for a mobile electronic device have been described in language specific to features or systems, the subject of the appended claims is not necessarily limited to the specific features or methods described. Rather, the specific features and methods are disclosed as example implementations of techniques and systems directed at integrated cellular and ultra-wideband antennas for a mobile electronic device, and other equivalent features and methods are intended to be within the scope of the appended claims. Further, various different aspects are described, and it is to be appreciated that each described aspect can be implemented independently or in connection with one or more other described aspects.

What is claimed is:

1. An antenna system for a mobile electronic device, the antenna system comprising:
a cellular antenna;
an ultra-wideband antenna; and
a circuit, the circuit connecting an ultra-wideband module to a feed port of the ultra-wideband antenna, the circuit and the ultra-wideband antenna configured to:
enhance isolation between the ultra-wideband antenna and the cellular antenna; and
provide resonance in a cellular band to enhance cellular bandwidth or efficiency.

2. The antenna system of claim 1, wherein:
the cellular antenna and the ultra-wideband antenna are integrated into a metal frame surrounding a perimeter of the mobile electronic device.

3. The antenna system of claim 2, wherein:
the ultra-wideband antenna, cellular antenna, and the metal frame are positioned coplanar to one another.

4. The antenna system of claim 3, wherein:
the ultra-wideband antenna is located proximate to the cellular antenna, the ultra-wideband antenna and the cellular antenna forming at least a portion of a first side of the metal frame;
the cellular antenna further forms a corner of the metal frame and extends past the corner to form at least a portion of a second side of the metal frame adjacent and orthogonal to the first side; and
a gap in the metal frame having a non-conductive material and separating the ultra-wideband antenna and the cellular antenna.

5. The antenna system of claim 1, wherein the circuit includes:
a shunt inductor connected to a ground in parallel with a capacitor that is in series with the ultra-wideband module.

6. The antenna system of claim 1, wherein the ultra-wideband antenna, the circuit, and the ultra-wideband module are together configured to transmit and receive ultra-wideband signals on bandwidths centered at 6.5 GHz and 8.0 GHz.

7. The antenna system of claim 1, wherein the ultra-wideband antenna comprises two ends including a first end and second end, the first end having a feed port and positioned closer to the cellular antenna than the second end, and the second end having a ground port.
